(19) United States
(12) Patent Application Publication
(10) Pub. No.: US 2009/0328023 A1
(43) Pub. Date: Dec. 31, 2009

(54) IMPLEMENTING OPTIMIZED INSTALLS AROUND PRE-INSTALL AND POST-INSTALL ACTIONS

(76) Inventors: Gregory Roger Bestland, Rochester, MN (US); Neela Shah, Rochester, MN (US); Carl Clair Pecinovsky, Rochester, MN (US); Brian Owen Wood, Byron, MN (US)

Correspondence Address: IBM CORPORATION;ROCHESTER IP LAW DEPT 917, 3605 HIGHWAY 52 N, ROCHESTER, MN, 55901-7829, US

(21) Appl. No.: 12/163,246

(22) Filed: Jun. 27, 2008

(51) Int. Cl. G06F 9/44

(52) U.S. Cl. 717/168

(57) ABSTRACT

A method, apparatus and computer program product are provided for implementing enhanced install performance of a computer system. A user request for an update to be installed is identified. The update to be installed is described by metadata. An installer is provided for installing one or multiple updates. Predefined information for each update to be installed, including any pre-installation operation and post-installation operation required by each update, is processed to provide enhanced install performance.

### FIELD OF THE INVENTION

The present invention relates generally to the data processing field, and more particularly, relates to a method, apparatus, and computer program product for implementing optimized installs around pre-install and post-install actions.

### DESCRIPTION OF THE RELATED ART

Known computer systems have the ability to install updates. Various arrangements are known for installing updates for a system; however, when managing many different types of updates for a computer system, each with their own dependencies and custom installers, the existing arrangements fail to optimize install performance.

When managing many different types of updates for a system, each with their own dependencies and custom installers, a need exists for a way to optimally sequence the installation of the updates and dependencies to minimize or eliminate redundant connections to a remote system, redundant invocations of installers, and redundant system restarts.

### SUMMARY OF THE INVENTION

Principal aspects of the present invention are to provide a method, apparatus and computer program product for implementing enhanced install performance of a computer system. Other important aspects of the present invention are to provide such method, apparatus and computer program product for implementing enhanced install performance of a computer system substantially without negative effect and that overcome many of the disadvantages of prior art arrangements.

In brief, a method, apparatus and computer program product for implementing enhanced install performance of a computer system. A user request for an update to be installed is identified. The update to be installed is described by metadata. An installer is provided for installing one or multiple updates. Predefined information for each update to be installed, including any pre-installation operation and post-installation operation required by each update, is processed to provide enhanced install performance.

In accordance with features of the invention, the predefined information processed for each update to be installed further includes the relative priority of the installer for an update versus other installers. The predefined information includes the classification of updates handled by the installer. The predefined information includes the installation dependencies between updates. The predefined information includes dynamic runtime provided information that overrides information including both update dependencies and restart implications. The predefined information includes automatic recalculation of dependencies upon an update installation or restart failure.

In accordance with features of the invention, the method and an installer manager optimize update installation for cross installer and platform dependencies. The method and an installer manager optimize pre-installation and post installation operations across installers and platforms. Sequencing of the updates is enabled across both operating systems and firmware, along with optimization of any restarts associated with the updates.

### BRIEF DESCRIPTION OF THE DRAWINGS

The present invention together with the above and other objects and advantages may best be understood from the following detailed description of the preferred embodiments of the invention illustrated in the drawings, wherein:

FIGS. 1A and 1B are block diagram representations illustrating an exemplary computer system for implementing enhanced install performance of the computer system in accordance with the preferred embodiment;

FIGS. 2A and 2B are flow charts illustrating exemplary steps for implementing enhanced install performance of the computer system in accordance with the preferred embodiment;

FIG. 3 is a block diagram illustrating a computer program product in accordance with the preferred embodiment.

### DETAILED DESCRIPTION OF THE PREFERRED EMBODIMENTS

As used in the following detailed description and claims, the following terms are defined as follows.

Installer: A computer program product or software that installs updates. The installer can communicate to an installer manager via a selected mechanism, such as, interfaces, XML, data store, and the like.

Pre-installation operations: Operation that must be completed before the installation of a given update can proceed. By definition none of the pre-installation operations can be deferred and must be completed prior to the update installation.

Post-installation operation: Operations that must be completed after the installation of an update. Two types of Post-installation operations include Immediate and Deferred Post-installation operation.

Immediate post-installation operations must be preformed before any dependent updates, or their pre-installation actions can be completed.

Deferred post-installation operation can be deferred until the end of the installation cycle. Dependent updates may be installed, and their corresponding pre/post installation operations may be completed.

Completion operation: Any pre-installation and post installation operation.

Update Dependency: An update has a dependency on another update if and only if the dependent update cannot be installed prior to the installation of the update that the dependent update has a dependency on. For example, if update 1 has a dependency on update 2, update 1 cannot be installed before update 2 is installed. Dependencies can be direct, for example, update 1 depends on update 2. Dependencies can also be indirect; for example, update 1 depends on update 2, which in turn depends on update 3. In this case update 1 has an indirect dependency on update 3.

Ready to Install: An update is defined as ready for install if and only if all of its pre-installation operations are complete, and any updates it has a dependency on are already installed.

In accordance with features of the invention, a method and installer manager provides an ability to manage cross installer and platform dependencies, and an ability to optimize pre-installation and post installation operations across installers and platforms. For example, consider a single physical central electronics complex (CEC) running two different virtualized operating systems. If both operating systems need different updates and the operating systems share common dependencies, for instance firmware updates, the present invention allows the sequencing of the updates, across both operating systems and firmware, along with optimization of any restarts associated with the updates.

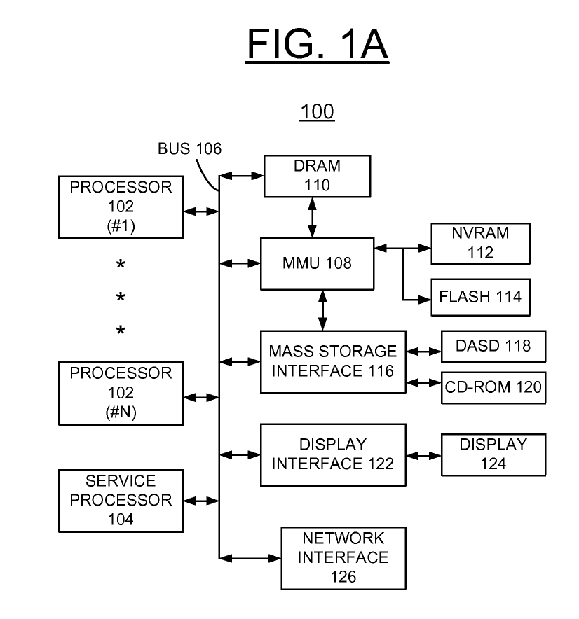

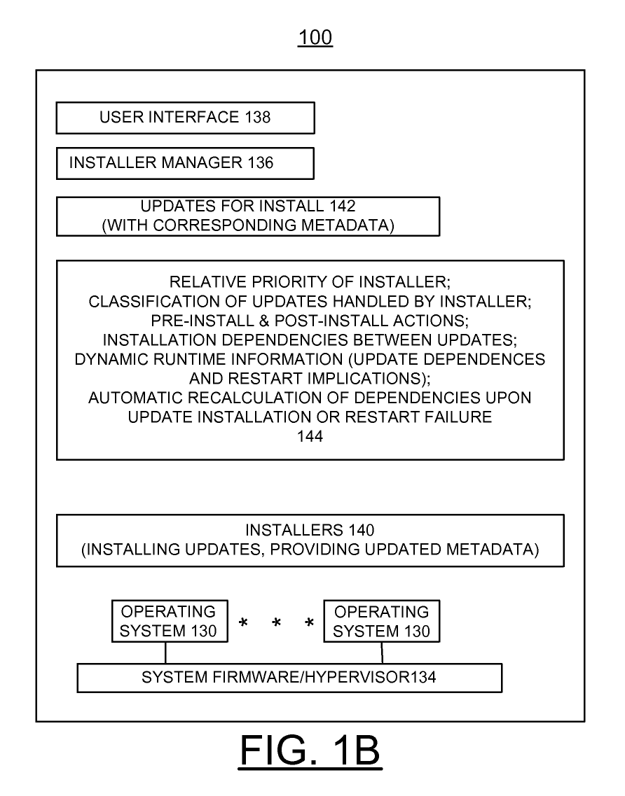

Referring now to the drawings, in FIGS. 1A and 1B there is shown an exemplary computer system generally designated by the reference character 100 for implementing enhanced install performance of the computer system in accordance with the preferred embodiment. Computer system 100 includes, for example, a plurality of processors 102, #1-N or central processor units (CPUs) 102, #1-N and a service processor 104 coupled by a system bus 106 to a memory management unit (MMU) 108 and system memory including a dynamic random access memory (DRAM) 110, a nonvolatile random access memory (NVRAM) 112, and a flash memory 114. The system bus 106 may be private or public, and it should be understood that the present invention is not limited to a particular bus topology used. A mass storage interface 116 coupled to the system bus 106 and MMU 108 connects a direct access storage device (DASD) 118 and a CD-ROM drive 120 to the main processor 102. Computer system 100 includes a display interface 122 connected to a display 124, and a network interface 126 coupled to the system bus 106.

Computer system 100 is shown in simplified form sufficient for understanding the present invention. The illustrated computer system 100 is not intended to imply architectural or functional limitations. The present invention can be used with various hardware implementations and systems and various other internal hardware devices.

As shown in FIG. 1B, computer system 100 includes a plurality of operating system 130, and a system firmware or hypervisor 134 including an install manager 136 of the preferred embodiment, and a user interface 138. At least one or each of a plurality of installers 140 in accordance with the preferred embodiment is capable of communicating with the install manager 136.

Installer 140 is responsible for installing updates, and providing updated metadata, if applicable. The installers 140 can be on the same computer system 100 or server as the install manager 136 or remotely located on a separate computer system 100 or server. In many instances, the installers 140 may delegate their work to native platform installers. Updates 142 to be installed are requested by a user. Updates 142, with corresponding metadata include pre-install actions or operations, post-install operations, and dependencies between updates. Each update 142 to be installed is described by metadata and has its own installer 140 or shares a particular installer 140 with other updates.

In accordance with features of the invention, to optimize the install of these updates 142, predefined information 144 is maintained and processed including the relative priority of the installer 140 running versus other installers 140. For instance, firmware should be applied before operating system updates. The predefined information 144 includes the classification of updates handled by the installer 140; for instance, “System X BIOS updates” versus “SLES Linux OS Updates.” The predefined information 144 includes any pre-install operations, and post-install operations required by the updates, such as pre-install and post install restarts. The predefined information 144 includes the installation dependencies between updates 142. The predefined information 144 includes dynamic runtime provided information that overrides the above information including both update dependencies and restart implications. The predefined information 144 includes the automatic recalculation of dependencies upon an update installation or restart failure.

In accordance with features of the invention, the install manager 136 is responsible for directing the installers 140 when to install updates 142 and when to perform pre-install actions and post-install actions 144. A primary role of the install manager 136 is to minimize calls to the installers 140, thereby eliminating extraneous remote connections and operations.

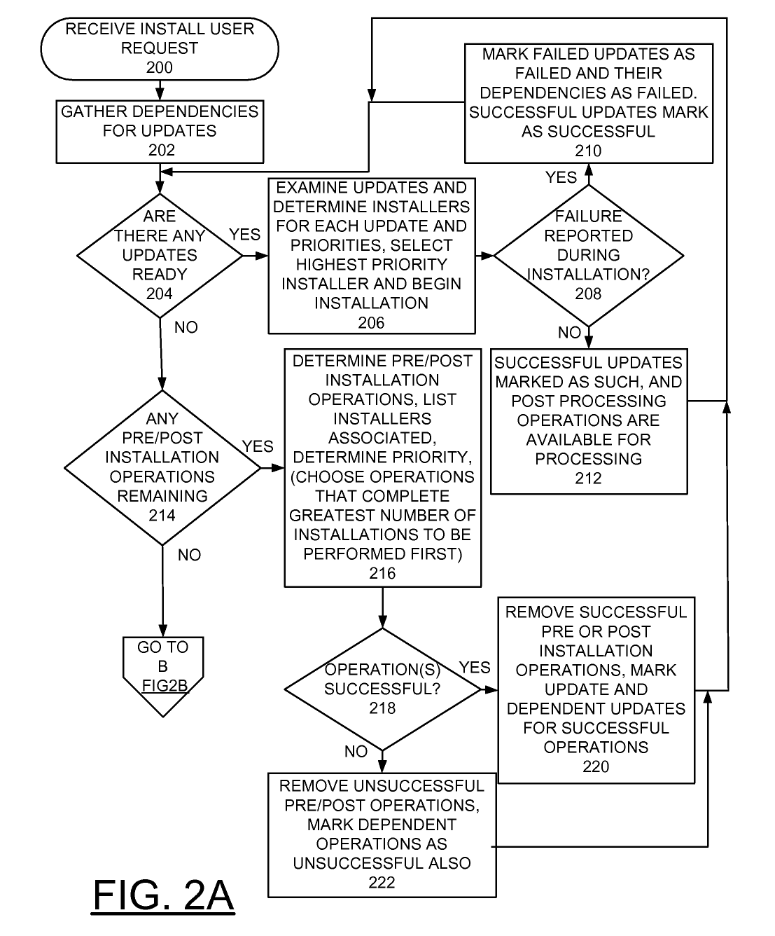

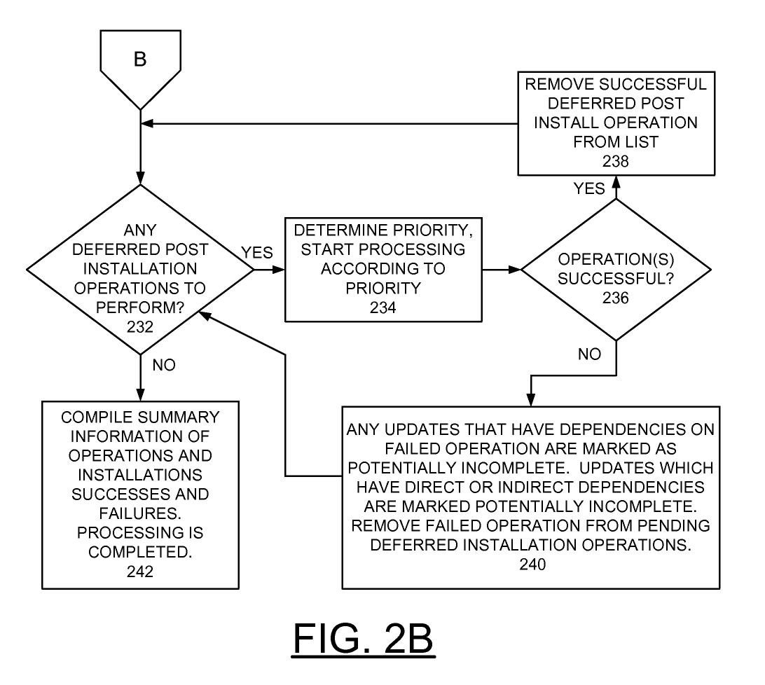

Referring now to FIGS. 2A and 2B, there are shown exemplary steps for implementing enhanced install performance of the computer system 100 in accordance with the preferred embodiment. First a request from the user for installation of specific updates is received as indicated at a block 200.

Before installation, the installer manager 136 starts by collecting information about the update dependencies between updates including the pre-install operations and post install operations associated with specific updates as indicated at a block 202. Gathering dependencies at block 202 is done by examining the metadata associated with the update, for example, typically defined in XML or if applicable, the installer 140 provides the information at runtime based upon the runtime environment. Checking for any updates ready for immediate install is performed as indicated at a decision block 204.

Once information about all the updates, implications of their dependencies, and the pre-install operations and post install operations associated with specific updates are collected at block 202, the installer manager 136 determines which updates are to be installed and in what sequence and when operations must be made to the required hardware and software components as indicated at a block 206. This is accomplished by starting with the updates that are to be installed and examining the metadata associated with the update including information 144 of the relative priority of the installer 140 running versus other installers, the installation dependencies between updates, and dynamic runtime provided information. Data from the installation dependencies between updates 144 is used, for example, to draw dependency relationships between the updates in order to form a dependency tree.

Once dependencies are determined, installation processing begins at block 206. During installation processing, updates with no other dependencies are installed first, which are leaf nodes on the update dependency tree. Before a leaf update can be installed, its pre-installation operations must be considered. If the update has pre-install operations, it is marked as “pending”, and will not be installed until all pre-install operations are completed. Updates that belong to same installer 140 and that are ready for install are batched together according to the information 144 of classification of updates handled by the installer 140, thereby eliminating duplicate remote connections and repeat calls to the same installer. The sequence of which installer is called first is determined by information 144 based upon installer priority.

Checking whether the installer reported a failure during installation is performed as indicated at a decision block 208. As indicated at a block 210, when the installer 140 reported failure with installation of an update, all updates which have a direct or indirect dependency on the failed update are to be removed from future processing because their dependencies would not be met to qualify for installation, and all updates having installations that were successful are marked as such, and their post installation operations are now available for processing. Then operations return to decision block 204 for checking for any immediate updates ready for installation.

As indicated at a block 212, when the installer 140 did not report a failure with installation of any update, then all updates whose installations were successful are marked as such and their post installation actions are now available for processing. Then operations return to decision block 204 for checking for any immediate updates ready for installation.

After each update immediately ready for installation is installed, checking is performed for any immediate pre-installation operation and post installation operation remaining to be performed as indicated at a decision block 214.

In accordance with the invention, when no more installations can be performed, updates with “pending” operations are considered. The pending operations are batched together based on the software/hardware resource targeted for restart. For instance, if two installed updates both have pending restarts on a particular system's operating system, these would be satisfied with one restart. When an update's pre/post install operation implications are satisfied, it is either marked as ready for installation in the case of satisfied pre-install operation satisfaction, or removed from the tree and any updates that are dependent upon it are available for install in the case of post install operation satisfaction.

When any immediate pre-installation operation and post installation operation remaining to be performed is identified, as indicated at a block 216 updates having any immediate pre-installation operation and post installation operation to be preformed are determined. A list of installers 140 associated with those updates is identified and the installer with the highest priority is chosen at block 216. Then a selected pre-installation operation or post installation action is submitted to be preformed and one immediate pre-installation operation or post installation operation for an update is performed by the identified installer 140 that has the highest priority at block 216. If multiple pre/post operations meet the criteria, the operation satisfying the greatest number of updates is chosen at block 216. For example, if two updates, require a restart of server 1 before the updates can be installed, and one update requires server 2 to be restarted before it can be installed. The restart of server 1 is selected since it fulfills multiple updates completion operations. It is also important to note, that while deferred post installation actions are not considered when picking which completion action to perform, any update, which corresponds to a an pre/post installation action which is performed successfully will be marked complete.

As indicated at a decision block 218, it is determined whether the completion operation submitted was completed successfully. When the completion operation submitted was completed successfully, then for all updates which had this pending operation, this pending operation is removed from their pre/post installation operation list and the update and dependent updates are marked based upon the successful operations as indicated at a block 220. If this was the only remaining pre-install operation, the update is now marked ready for installation, and if it was their only remaining immediate post installation operation the update is now completed, and any updates which have a direct dependency on the newly completed update are ready for processing at block 220.

If any of the update installations fail as indicated at decision block 208, the processing eliminates any update dependencies that are no longer applicable based upon automatic recalculation of dependences upon update installation or restart failure 144 at block 210. Should an installer 140 report a failure at block 208 either with an update's installation or either with its corresponding pre-installation operations and post installation operations at block 218, that node is immediately removed from the dependency tree. Also any updates, which have a dependency upon that failed update, are also removed along with their pre-installation operation and post installation operation implications at block 210. This leaves only updates to be installed that have no dependencies, either direct or indirect, on the failed update, and the runtime is able to attempt the maximum number of installations pursuant from the original request.

For example, when the update has no post installation operation implications, the update is removed from the tree and any updates that are dependent upon it are available for installation at block 220. If the update has post install operation implications that need to be performed, the update remains in the tree and is marked as installed but not complete. Then operations return to decision block 204 for checking for any immediate updates ready for installation. This continues until no more updates can be installed.

When the completion operation submitted was not completed successfully, then all updates, which had this pending operation are removed from future processing because either these updates are not ready for installation or their installation is not complete as indicated at a block 222. Any updates, which had direct, or indirect dependencies on the pending updates, are removed because these updates will not be ready for installation due to dependencies not being met. Then operations return to decision block 204 for checking for any immediate updates ready for installation.

When determined that no updates are left for installation and no immediate pre-installation operation or post installation operation is remaining to be performed at decision blocks 204 and 214, then continuing following B in FIG. 2B, checking is performed for any deferred post installation operations to perform as indicated at a decision block 232.

When any deferred post installation operations to be performed is identified, then it is determined which deferred operations' update's installer has the highest priority, and that one is processed first and the selected operation is submitted for completion as indicated at a block 234. If multiple deferred operations meet the criteria, then starting with whichever one will satisfy the most updates is performed. For example, when two updates require a deferred operation that restarts server 1, and one update has a deferred operation which requires a restart of server 2, and all three updates share the same installer which has the highest priority, then restarting server 1 would be selected because this satisfies two updates' deferred operation.

Checking is performed to determine whether the selected deferred post install operation was completed successfully as indicated at a decision block 236. When the selected deferred post install operation was completed successfully, then the selected deferred post install operation is removed from the list of pending deferred install operations, for any applicable updates as indicated at a block 238. Updates that have no further pending deferred post install operations are now complete. Then operations return to decision block 232 for checking for any deferred post install operations to perform.

When the selected deferred post install operation was not completed successfully, then any updates that have a dependency on the failed deferred installation operation, are marked as potentially incomplete, any updates which have a direct or indirect dependency on the potentially incomplete updates are also marked as potentially incomplete as indicated at a block 240. The failed deferred install operation is removed from the list of pending deferred installation operations. Then operations return to decision block 232 for checking for any deferred post install operations to perform.

When no deferred post installation operations to perform are identified at decision block 232, then all pre-install operations and post install operations have been attempted, and all update installations have also been attempted, summary information from failures/successes is compiled, and processing is completed as indicated at a block 242.

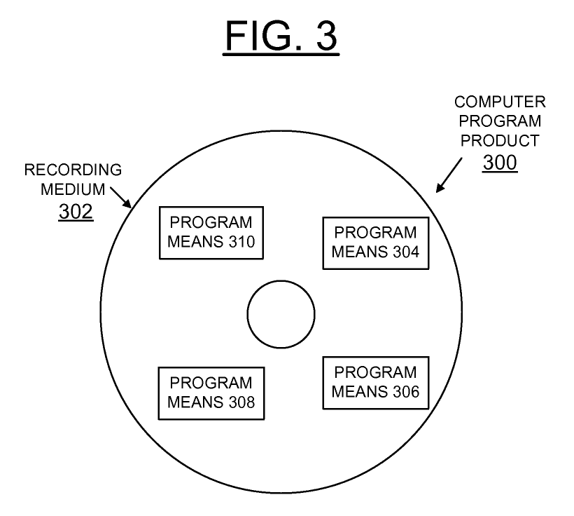

Referring now to FIG. 3, an article of manufacture or a computer program product 300 of the invention is illustrated. The computer program product 300 includes a computer readable recording medium 302, such as, a floppy disk, a high capacity read only memory in the form of an optically read compact disk or CD-ROM, a tape, or another similar computer program product. Computer readable recording medium 302 stores program means 304, 306, 308, 310 on the medium 302 for carrying out the methods for implementing enhanced install performance of the computer system 100 of FIG. 1 of the preferred embodiment.

A sequence of program instructions or a logical assembly of one or more interrelated modules defined by the recorded program means 304, 306, 308, 310, direct the computer system 100 for implementing enhanced install performance of the preferred embodiment.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

While the present invention has been described with reference to the details of the embodiments of the invention shown in the drawing, these details are not intended to limit the scope of the invention as claimed in the appended claims.

What is claimed is:

1. A computer-implemented method for implementing enhanced install performance of a computer system comprises:
receiving a user request for an update to be installed; said update to be installed including predefined information and being described by metadata;
providing an installer for installing one or multiple updates; and
processing predefined information for each update to be installed, including any pre-installation operation and post-installation operation required by each update, to provide enhanced install performance.

2. The computer-implemented method as recited in claim 1 wherein processing predefined information for each update to be installed includes identifying a relative priority of the installer for an update versus other installers.

3. The computer-implemented method as recited in claim 1 wherein processing predefined information for each update to be installed includes identifying a classification of updates handled by said installer.

4. The computer-implemented method as recited in claim 1 wherein processing predefined information for each update to be installed includes identifying installation dependencies between the updates.

5. The computer-implemented method as recited in claim 1 wherein processing predefined information for each update to be installed includes identifying dynamic runtime information.

6. The computer-implemented method as recited in claim 1 wherein processing predefined information for each update to be installed includes automatic recalculation of dependencies based upon an update installation.

7. The computer-implemented method as recited in claim 1 wherein processing predefined information for each update to be installed includes automatic recalculation of dependencies based upon a failed update installation.

8. The computer-implemented method as recited in claim 1 includes identifying the update as ready to install based upon a priority of the installer for the update.

9. The computer-implemented method as recited in claim 1 includes identifying the update as ready to install based upon update dependencies between a plurality of updates.

10. The computer-implemented method as recited in claim 1 includes identifying the update as ready to install based upon any said pre-installation operation and said post-installation operation required by the update.

11. A computer program product embodied on a computer readable storage medium for implementing enhanced performance of a computer system, said computer readable storage medium storing instructions, and said instructions when executed by the computer system cause the computer system to perform the steps comprising:
receiving a user request for an update to be installed; said update to be installed including predefined information and being described by metadata;
providing an installer for installing one or multiple updates; and
processing predefined information for each update to be installed, including any pre-installation operation and post-installation operation required by each update, to provide enhanced install performance.

12. The computer program product as recited in claim 11 further comprises identifying the update as ready to install based upon a priority of the installer for the update.

13. The computer program product as recited in claim 11 further comprises identifying the update as ready to install based upon update dependencies between a plurality of updates and the update.

14. The computer program product as recited in claim 11 further comprises identifying the update as ready to install based upon any said pre-installation operation and said post-installation operation required by the update.

15. The computer program product as recited in claim 11 wherein said predefined information for each update to be installed include a priority of the installer for the update.

16. The computer program product as recited in claim 11 wherein said predefined information for each update to be installed includes installation dependencies between a plurality of updates and the update.

17. The computer program product as recited in claim 11 wherein said predefined information for each update to be installed includes dynamic runtime information.

18. An apparatus for implementing enhanced install performance of a computer system comprises:
an installer manager embodied on a computer readable storage medium for receiving a user request for an update to be installed; said update to be installed including predefined information and being described by metadata;
said installer manager for collecting and processing predefined information for each update to be installed, including any pre-installation operation and post-installation operation required by each update, to provide enhanced install performance; and
an installer for communicating with said installer manager and for installing updates responsive to said installer manager.

19. The apparatus for implementing enhanced install performance as recited in claim 18 wherein said installer manager identifies an update as ready to install based upon a priority of the installer for the update.

20. The apparatus for implementing enhanced install performance as recited in claim 18 wherein said installer communicates dynamic runtime information to said installer manager.
